(19) United States
(12) Patent Application Publication
(10) Pub. No.: US 2024/0156251 A1
(43) Pub. Date: May 16, 2024

(54) USER INTERFACE FOR HEIGHT ADJUSTABLE TABLES

(71) Applicant: MILLERKNOLL, INC., ZEELAND, MI (US)

(72) Inventor: Adam Daley-Fell, Zeeland, MI (US)

(21) Appl. No.: 18/548,820

(22) PCT Filed: Mar. 3, 2022
(86) PCT No.: PCT/US2022/018740

§ 371 Date: Sep. 1, 2023

Related U.S. Application Data
(60) Provisional application No. 63/156,139, filed on Mar. 3, 2021.

(51) Int. Cl. A47B 9/00

(52) U.S. Cl. CPC A47B 9/00; A47B 2200/0042; A47B 2200/0062

(57) ABSTRACT

A user interface for a height adjustable table includes a memory for storing protocol information for a number of communication protocols, and an electronic processor configured to generate instructions for a controller of the height adjustable table, receive the protocol information from the memory, and generate a first instruction for the control box based one of the communication protocols included in the protocol information, and monitor for a first response from the controller. The electronic processor is further configured to determine whether the first response is an expected response based on the first instruction, generate a second instruction for the controller in response to the first response not being the expected response, and monitor for a second response from the controller. The electronic processor also determines whether the second response is the expected response and continues issuing subsequent instructions based on the second response not being the expected response.

### CROSS-REFERENCE TO RELATED APPLICATIONS

This application claims priority to, and the benefit of, U.S. Provisional Patent Application No. 63/156,139, filed Mar. 3, 2021, the entire contents of which are incorporated by reference herein.

### FIELD OF THE INVENTION

The present invention relates to user interfaces for height adjustable tables and, more particularly, to a user interface configured to control different height adjustable tables.

### SUMMARY

One embodiment described herein provides a user interface for a height adjustable table. The user interface includes a memory configured to store protocol information for a number of communication protocols and an electronic processor. The electronic processor is configured to receive the protocol information from the memory and generate a first instruction for a controller of the height adjustable table based on a first communication protocol of the number of communication protocols stored in the memory. The electronic processor is also configured to monitor for a first response from the controller, determine whether the first response is an expected response based on the first instruction, and generate a second instruction for the controller based on a second communication protocol of the plurality of communication protocols in response to the first response not being the expected response. The electronic processor is further configured to monitor for a second response from the controller, determine whether the second response is the expected response based on the second instruction, and continue issuing subsequent instructions based on the second response not being determined to be the expected response.

In one aspect, the electronic processor is further configured to control a motor to vary the height of the height adjustable table in response to receiving the expected response.

In another aspect, the expected response includes at least one of a group consisting of a predefined voltage value, a predefined current value, and an acknowledgement message.

In another aspect, the first instruction is an instruction associated with a Local Interconnect Network (LIN) protocol.

In another aspect, the generated instructions are associated with an electrical connector coupling the user interface to the controller.

In another aspect, the electrical connector is one of a DIN connector, an RJ-45 connector, and a four-pin square connector.

In another aspect, the user interface is coupled to the controller via a universal connector.

In another embodiment, a method for controlling a height adjustable workstation is described, according to some embodiments. The method includes receiving, at an electronic processor, protocol information from a memory in communication with the electronic processor and generating a first instruction for a controller of the height adjustable workstation based on a first communication protocol of a plurality of communication protocols stored in the protocol information. The method further includes monitoring, by the electronic processor, for a first response from the controller and determining whether the first response is an expected response based on the first instruction. The method also includes controlling a motor of the height adjustable workstation based on the first response being determined to be the expected response.

In one aspect, the method also includes generating, at the electronic processor, a second instruction for the controller based on a second communication protocol of the plurality of communication protocols stored in the protocol information in response to the first response being determined to not be the expected response, monitoring for a second response from the controller, and determining whether the second response is the expected response based on the second instruction. The method also includes controlling the motor of the height adjustable workstation based on the second response being determined to be the expected response.

In another aspect, the method also includes issuing, by the electronic processor, subsequent instructions in response to the second response being determined to not be the expected response until the expected response is received.

In another aspect, the expected response includes at least one of a group consisting of a predefined voltage value, a predefined current value, and an acknowledgment message.

In another aspect, the first instruction is a Local Interconnect Network (LIN) based instruction.

In another aspect, the generated instructions are associated with an electrical connector coupling the user interface to the controller.

In another aspect, the electrical connector is one of a DIN connector, an RJ-45 connector, and a four-pin square connector.

In another aspect, the user interface is coupled to the controller via a universal connector.

In another embodiment, a height adjustable table is described. The height adjustable table includes a tabletop, a leg coupled to the tabletop, and an actuator positioned within the leg and configured to raise and lower the tabletop. The height adjustable table further includes a user interface configured to receive a user input for controlling the actuator. The user interface includes a memory configured to store protocol information for a plurality of communication protocols and an electronic processor. The electronic processor is configured to receive the protocol information from the memory and generate a first instruction for a controller associated with the actuator based on a first communication protocol of the plurality of communication protocols stored in the protocol information. The electronic processor is further configured to monitor for a first response from the controller, determine whether the first response is an expected response based on the instruction, and generate a second instruction for a controller based on a second communication protocol of the plurality of communication protocols in response to the first response not being the expected response. The electronic processor is also configured to monitor for a second response from the controller, determine whether the second response is the expected response based on the second instruction, and continue issuing subsequent instructions based on the second response not being the expected response.

In one aspect, the electronic processor is further configured to control the actuator to vary the height of the height adjustable table in response to receiving the expected response.

In another aspect, the expected response includes one of a group consisting of a predefined voltage value, a predefined current value, and an acknowledgement message.

In another aspect, the first instruction is an instruction associated with a Local Interconnect Network (LIN) protocol.

In another aspect, the generate instructions are associated with an electrical connector coupling the user interface to the controller, wherein the electrical connector is one of a DIN connector, and RJ-45 connector, and a four-pin square connector.

Other aspects of the invention will become apparent by consideration of the detailed description and accompanying drawings.

### BRIEF DESCRIPTION OF THE DRAWINGS

FIG. 1 is a perspective view of a height adjustable table including a user interface according to an embodiment of the present invention.

FIG. 2 is a block diagram of the user interface connected to actuators of one of the height adjustable tables.

FIG. 3 is a schematic of the user interface connectable to different height adjustable tables.

FIG. 4 is a flowchart depicting operation of the user interface.

### DETAILED DESCRIPTION

Before any embodiments are explained in detail, it is to be understood that the technology described herein is not limited in its application to the details of construction and the arrangement of components set forth in the following description or illustrated in the following drawings. The described technology is capable of other embodiments and of being practiced or of being carried out in various ways.

Various hardware and software-based devices, as well as different structural components may be used to implement various embodiments. In addition, embodiments may include hardware, software, and electronic components or modules that, for purposes of discussion, may be illustrated and described as if most of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more electronic processors. For example, “control units” and “controllers” described in the specification can include one or more electronic processors, one or more memory modules including non-transitory computer-readable medium, one or more input/output interfaces, one or more application specific integrated circuits (ASICs), one or more system on a chip (SOCs), and various connections (for example, a system bus) connecting the various components.

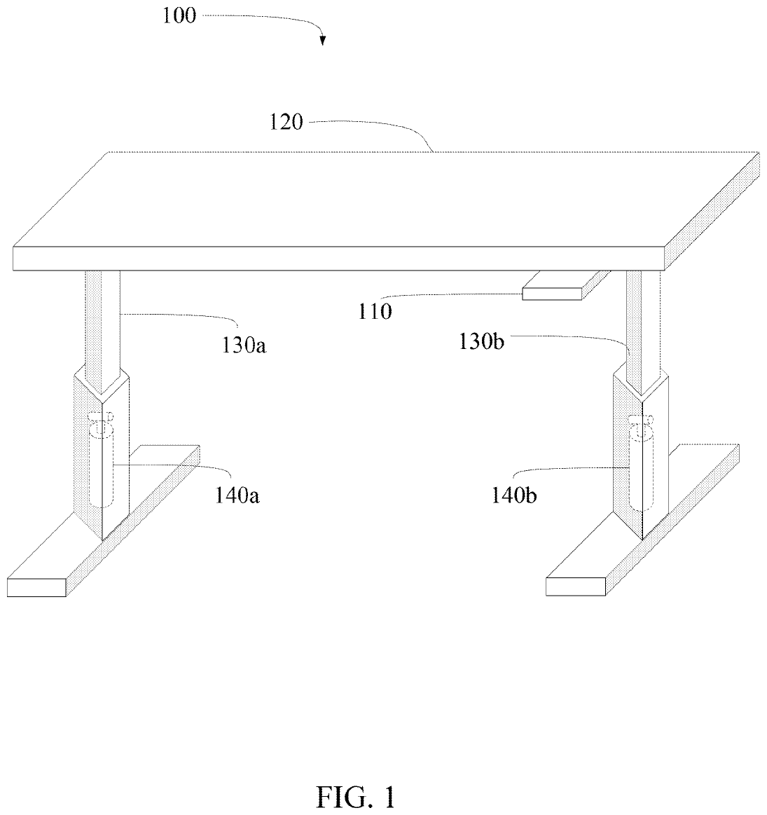

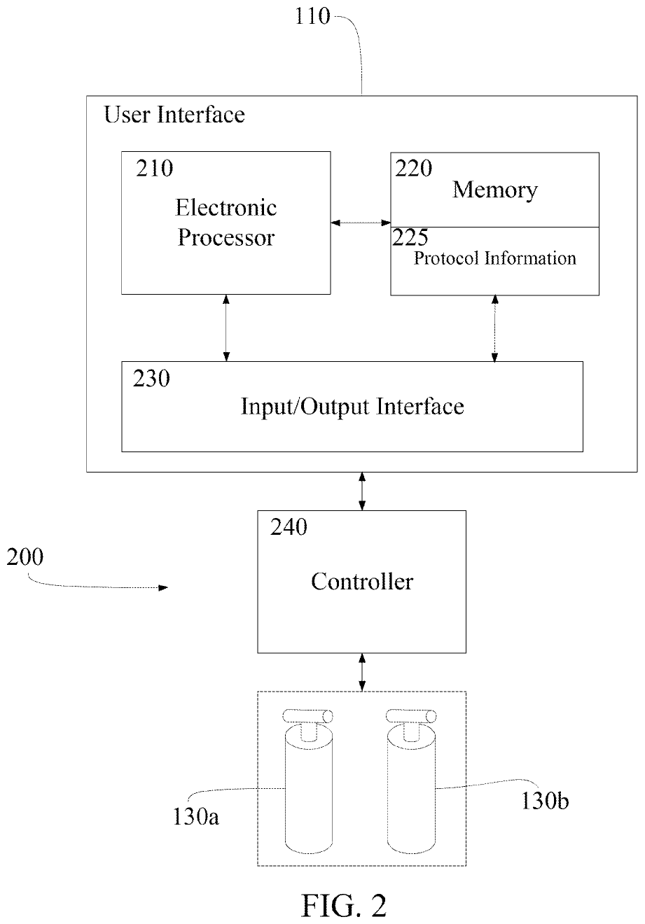

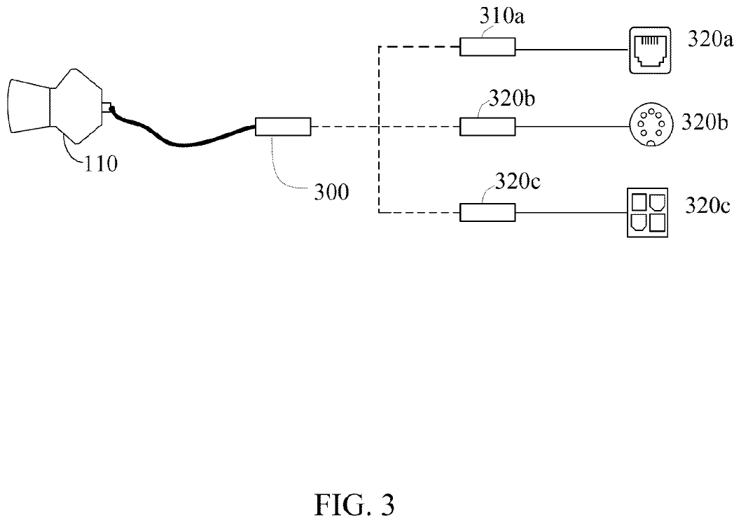

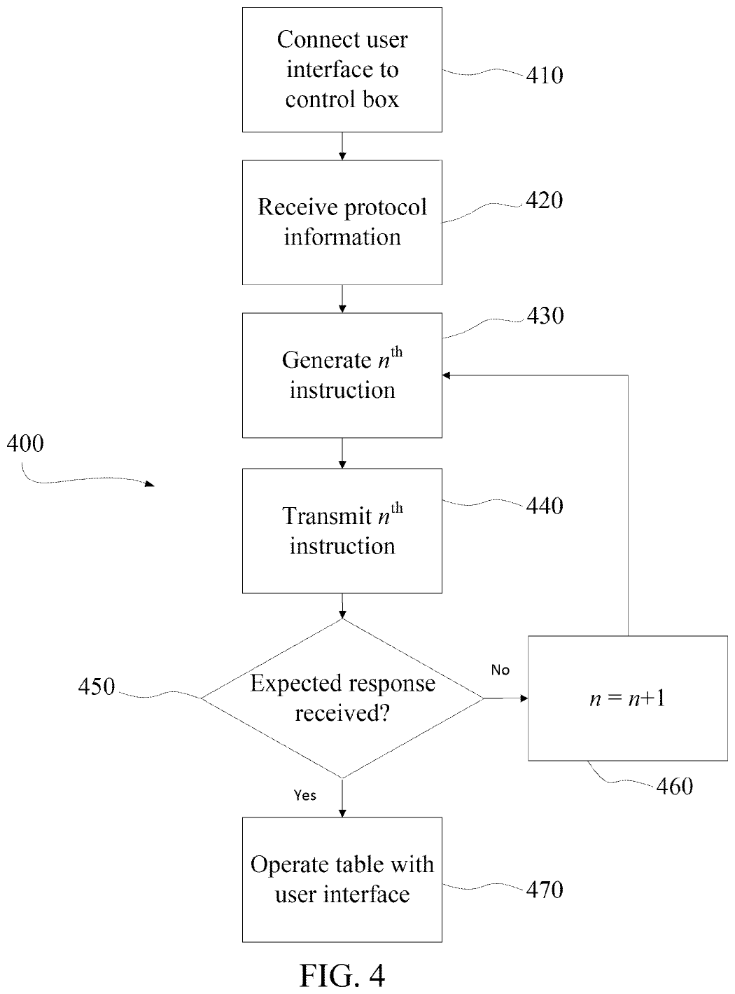

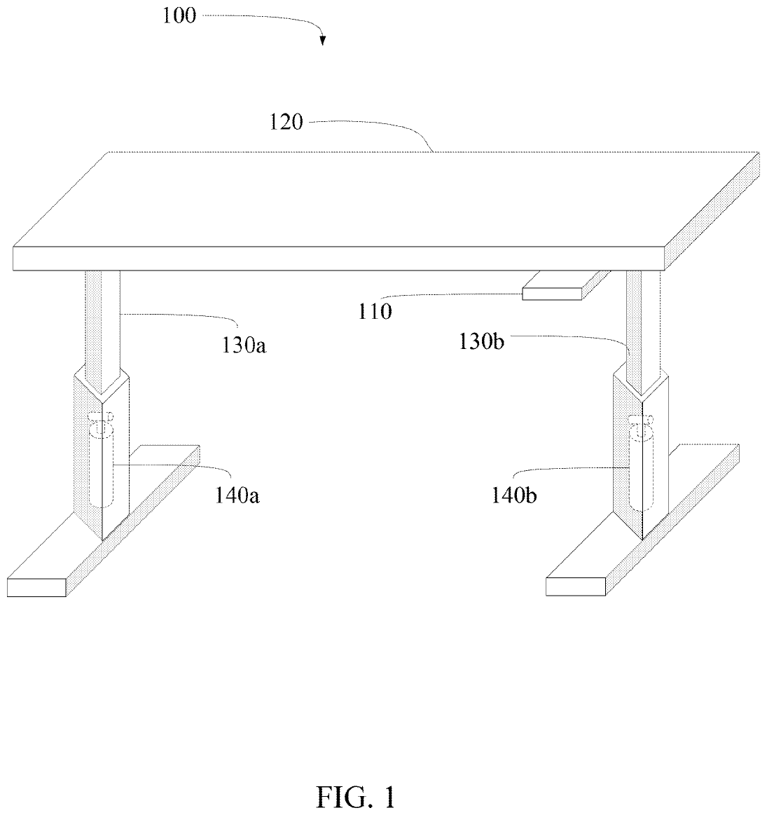

FIG. 1 illustrates a possible embodiment of a height adjustable table 100. The height adjustable table 100 is adjustable to a variety of different heights, including a sitting height, a standing height, and/or a perched height. The illustrated height adjustable table 100 includes a tabletop 120 and one or more legs 130a, 130b. The legs 130a, 130b are coupled to the tabletop 120 and support the height adjustable table 100 on the ground or other surface. The legs 130a, 130b are adjustable to change a height of the tabletop 120 relative to the ground or other surface upon which the height adjustable table 100 is positioned. In some embodiments, the legs 130a, 130b may telescope to change the height of the tabletop 120.

The height adjustable table 100 also includes one or more actuators 140a, 140b. The actuators 140a, 140b are coupled to or positioned within the legs 130a, 130b for controlling movement (e.g., height adjustment) of the height adjustable table 100. In one embodiment, the actuators 140a, 140b are linear actuators that control vertical motion of the tabletop 120 of the height adjustable table 100. In other embodiments, the actuators 140a, 140b may be other suitable types of actuators, such as belt and pulley systems, gear systems, and the like. In some embodiments, the height adjustable table 100 may include only a single actuator (such as actuator 140a or actuator 140b).

The illustrated height adjustable table 100 also includes a user interface 110. In the illustrated embodiment, the user interface 110 is mounted to the tabletop 120. In other embodiments, the user interface 110 may be coupled to a different part of the height adjustable table 100, such as one of the legs 130a, 130b, or may be spaced apart from the height adjustable table 100. The user interface 110 is electrically coupled to the actuators 140a, 140b to cause movement of the actuators 140a, 140b. In one embodiment, the user interface 110 may be electrically coupled to the actuators 140a, 140b through a wired connection. Alternatively, the user interface 110 may be electrically coupled to the actuators 140a, 140b through a wireless connection. In some embodiments, the user interface 110 may include an input mechanism 150. For example, the input mechanism 150 may be a paddle. In other embodiments, the input mechanism 150 may include a switch, a dial, a keypad, a touchscreen, or other suitable interface with which a user can interact. The input mechanism 150 is configured to provide an input to the user interface 110 based on a user interaction with the input mechanism 150.

The height adjustable table 100 further includes a controller 160. The controller 160 may be integrated with, or coupled to, the actuators 140a, 140b. In one embodiment, a single controller 160 is electrically coupled to both actuators 140a, 140b. The controller 160 may be configured to control the operation of the actuators 140a, 140b, and therefore the height adjustment of the height adjustable table, based on an input received from the user interface 110. In some examples, the controller 160 is a proprietary controller associated with the actuators 140a, 140b.

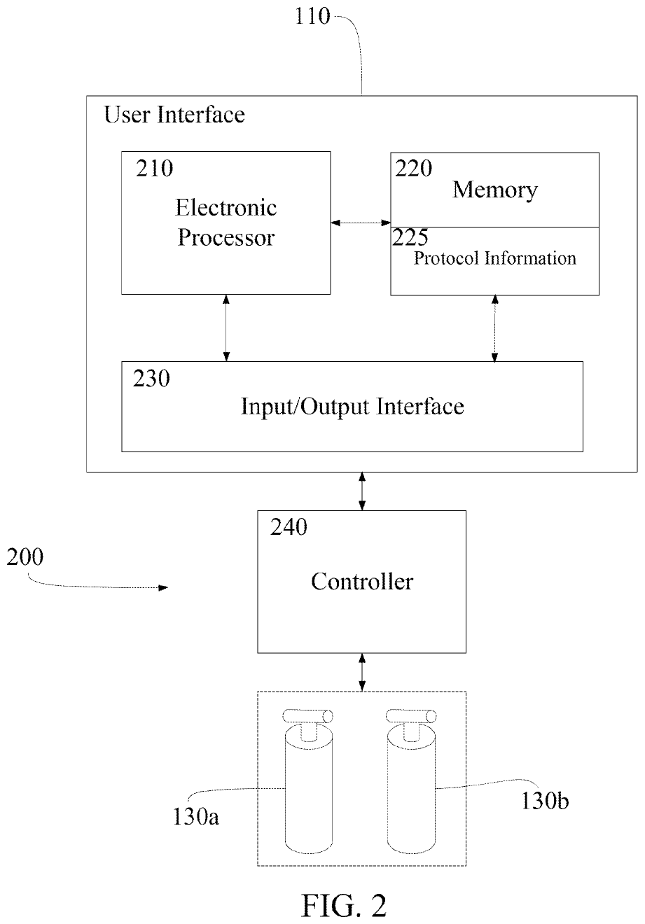

FIG. 2 is a block diagram of a system 200 associated with a height adjustable table, such as height adjustable table 100. As shown in FIG. 2, the system 200 includes the user interface 110, controller 160 the controller 160, and the one or more actuators 140a, 140b.

The controller 160 is communicatively coupled to the actuators 140a, 140b via wired or wireless connections. Although the controller 160 is illustrated separately from the user interface 110, in some embodiments, the controller 160 is part of the user interface 110. In other embodiments, the controller 160 may be part of the height adjustable table or the actuators 140a, 140b. The controller 160 is configured to, among other things, receive signals from the user interface 110 and provide instructions to the actuators 140a, 140b to control movement of the actuators 140a, 140b. In some embodiments, the controller 160 is controlled via a controller such as the user interface 110 and is configured to operate with a predetermined communication protocol and electrical connector interface.

The user interface 110 is communicatively coupled to the controller 160 via a wired or wireless connection. The user interface 110 includes various electronic components that provide power, operation control, and protection to the components and modules within the user interface 110. In the example illustrated, the user interface 110 includes the input mechanism 150, an electronic processor 210 (such as a programmable electronic microprocessor, microcontroller, or similar device), a memory 220 (for example, non-transitory, machine-readable memory), and an input-output (“I/O”) interface 230. The electronic processor 210 is communicatively connected to the memory 220 and the I/O interface 230. The electronic processor 210, in coordination with the memory 220 and the I/O interface 230, is configured to implement, among other things, the various processes described herein.

In some embodiments, the memory 220 stores protocol information 225. The protocol information 225 may include information for a number of different communication protocols for communicating with various controllers, such as controller 160. As the controller 160 may be specific to the actuators 140a, 140b, various communication protocols may be required to communicate with the controller 160 depending on what type of controller is being used. In some embodiments, the protocol information 225 includes information related to various communication protocols and/or electrical connector interfaces that are known to be utilized by manufacturers of controllers 160 and actuators 140a, 140b for use in height adjustable tables, such as height adjustable table 100.

In some embodiments, the user interface 110 may be implemented using multiple electronic processors 210 or several independent controllers (for example, programmable electronic control units) each configured to perform specific functions or sub-functions of the user interface 110. Additionally, the user interface 110 may contain sub-modules that include additional electronic processors, memory, application-specific integrated circuits (ASICs), or one or more system on a chip (SOCs) for handling input-output functions, processing of signals, and application of the methods listed below. In other embodiments, the user interface 110 includes additional, fewer, or different components.

The user interface 110 may receive a user input via the input mechanism 150. For example, the input mechanism 150 may be actuated by a user to provide an instruction to raise and/or lower the tabletop 120 of the height adjustable table 100. The instruction may be recited by the electronic processor 210, which may provide an instruction to the controller 160 via the I/O interface 230, as will be described in more detail below. In response to receiving the instruction, the controller 160 is configured to control the actuators 140a, 140b to raise or lower the tabletop 120 of the height adjustable table 100 based on the input provided via the input mechanism 150.

As described in more detail below, a standard user interface 110 may be used for various height adjustable tables, such as height adjustable table 100. However, various controllers and actuators may be present in height adjustable tables, whether from a single manufacturer, or across the industry in general. These controllers and/or actuators may require specific communication protocols to be used in order to allow the user interface 110 to function properly.

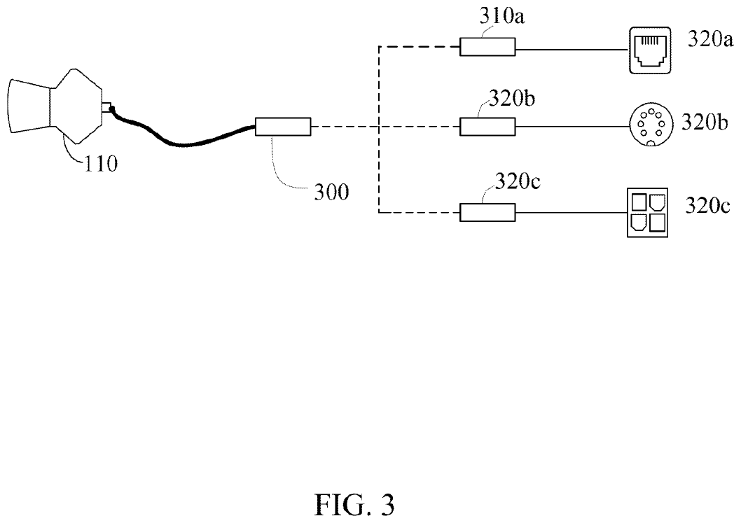

FIG. 3 illustrates the user interface 110 selectively coupled to different electrical connectors 320a, 320b, 320c of various height adjustable tables. As discussed above, different height adjustable tables may have a different configuration and, specifically, a different type of actuator(s) for adjusting the height of a tabletop. The user interface 110 is configured to be independently usable with a variety of different height adjustable tables to control each table (e.g., adjust the height). For example, the user interface 110 may be connected to one of the height adjustable tables to send signals to change heights (e.g., raise, lower, move to a specified height, etc.). In some embodiments, the user interface 110 may be installed on the desired height adjustable table during manufacture. In other embodiments, the user interface 110 may be installed on the desired height adjustable table by an end user.

In the example shown in FIG. 3, the user interface 110 may be selectively coupled to electrical connectors 320a, 320b, 320c. Each of the electrical connectors 320a, 320b, 320c represent different electrical connectors of different height adjustable tables. For example, electrical connector 320a is shown as an RJ-45 style connector, electrical connector 320b is shown as a DIN type connector, and electrical connector 320c is shown as a four-pin square connector. However, other connector types may also be used as appropriate for a given application, such as RJ-12, DIN 45329, etc. As shown in FIG. 3, the user interface 110 includes a user interface connector 300. The user interface connector 300 may be selectively coupled to a single connector adapter 310a, 310b, 310c. The connector adapters 310a, 310b, 310c are configured to provide a connection between the user interface connector 300 and the various electrical connectors 320a, 320b, 320c. For example, the connector adapter 310a is configured to interface with electrical connector 320a, the connector adapter 310b is configured to interface with electrical connector 320b, and the connector adapter 310c is configured to interface with electrical connector 320c. It is understood that additional connector adaptors may be used to connect with other electrical connector types, as required for a given application. In one embodiment, three or more connector adaptors may be positioned on the user interface connector 300 to allow for a single cable to be used for a variety of connections.

In response to the user interface connector 300 being coupled to any of the electrical connectors 320a, 320b, 320c through one of the connector adapters 310a, 310b, 310c, the user interface 110 is configured to provide a control signal to one of the electrical connectors 320a, 320b, 320c in response to a user input provided via the input mechanism 150. For example, in response to the user interface connector 300 being coupled to one of the electrical connectors 320a, 320b, 320c via the appropriate connector adapter 310a, 310b, 310c, the user interface 110 generates a control signal that is provided to the controller 160 via the associated electrical connector 320a, 320b, 320c indicating a desired operation (e.g., raise/lower) based on an input via the input mechanism 150. In some embodiments, a handshake or other initialization signal is provided to the controller 160 via one of the electrical connectors 320a, 320b, 320c from the user interface 110. The handshake signal is used to determine the appropriate communication protocol to use with the controller 160 by the user interface 110 and will be described in more detail below.

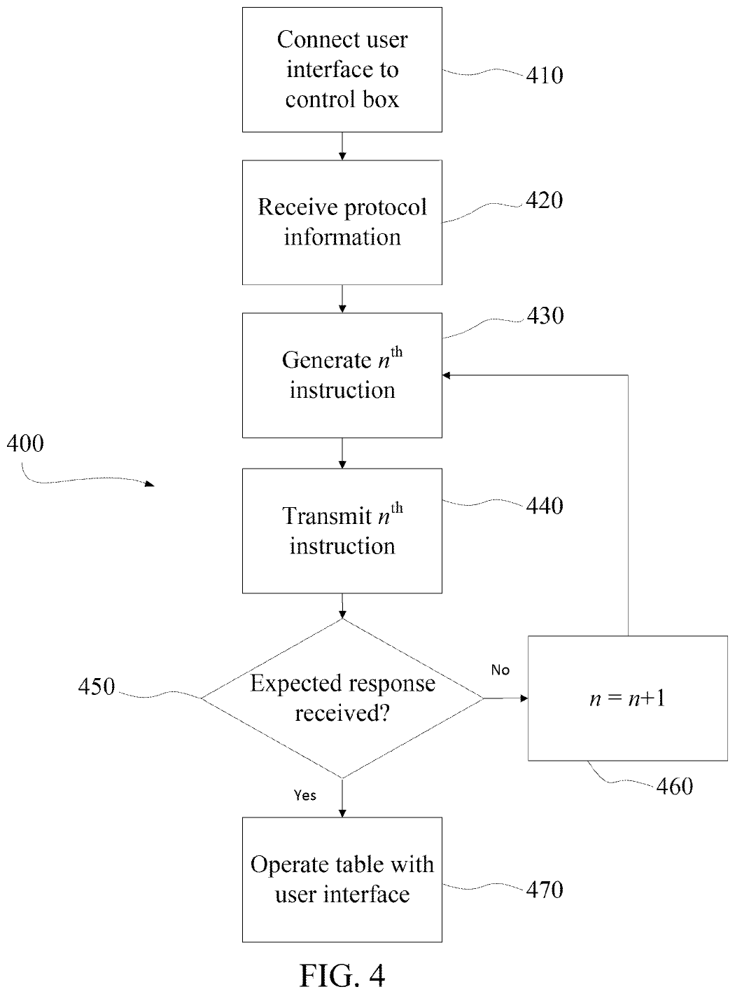

FIG. 4 is a flow chart illustrating a process 400 of establishing communication between a user interface, such as user interface 110, and a controller, such as controller 160, of a height adjustable table, such as height adjustable table 100. Specifically, the process 400 is directed to allowing the user interface 110 to establish communication with a variety of controller types to allow for a single user interface to be used for various combinations of controllers and actuators used in height adjustable tables. In one embodiment, the electronic processor 210 executes the process 400 based on instructions stored in the memory 220.

At process block 410 the user interface 110 is connected to the controller 160. In one embodiment, the user interface 110 is coupled to the controller 160 via the one or more connector adapters 310a, 310b, 310c as described above with respect to FIG. 3. In one embodiment, the user interface 110 may be connected to the controller 160 by a manufacturer of the height adjustable table 100, an end user, or the like.

At process block 420 the electronic processor 210 determines whether the user interface 110 has previously established communication with the controller 160. For example, the electronic processor 210 may have previously established communication with the controller 160, and stored the established communication in the memory 220. In some examples, the electronic processor 210 may determine that it has previously established communication with the controller 160 where no power reset has occurred since the last communication with the controller 160. In response to determining that the user interface 110 has previously established communication with the controller 160, the user interface 110 operates in a normal operation mode and communicates commands received from the input mechanism 150 to the controller 160 at process block 430. In response to determining that the user interface has not previously been connected to the controller 160, the process 400 proceeds to process block 440. In some examples, where a power reset or other intervening event (e.g., communication error, manual reset, etc.) has occurred, the electronic processor 210 proceeds to step 440 of the process 400 to verify communication with the controller 160. In some examples, the electronic processor 210 may bypass process block 410 and always verify communication with the controller 160.

At process block 440 the electronic processor 210 accesses communication protocols associated with the protocol information 225 stored in the memory 220. In some embodiments, the protocol information 225 is stored in the memory 220 during manufacturing. However, in some embodiments, the protocol information 225 may be stored in the memory 220 at other times, such as via a user update. In one embodiment, the protocol information 225 contains communication protocol information, such as Local Interconnect Network (LIN) protocol, Direct Contact protocol, Controller Area Network (CAN) bus protocol, and/or other proprietary communication protocols associated with the controller 160. The communication protocol information may be associated with various systems, such as Logicdata, OMT Vehyl, Linak Control Box, JieCang Linear Motion, OMT, and the like. The protocol information 225 further includes information regarding variety of electrical connectors. For example, the protocol information 225 may include information about the configuration of hardware lines (e.g., LIN wire, serial wire, etc.) for a variety of electrical connectors that are known to be utilized by manufacturers of height adjustable tables (such as electrical connectors 320a, 320b, 320c). In some embodiments, a specific communication protocol may be able to be utilized across various electrical connectors. However, in other embodiments, some communication protocols may be associated with specific connector types. It is to be appreciated that although the protocol information 225 is described as including information regarding specific communication protocols and/or associated electrical connectors, the protocol information 225 may include information regarding a variety of different communication protocols and electrical connectors not explicitly listed herein.

At process block 450, the electronic processor 210 generates a first instruction. In one embodiment the electronic processor 210 generates the instruction based the protocol information 225 stored in the memory 220 of the user interface 110. In some embodiments, the electronic processor 210 may select the first instruction based on a ranking of the communication protocols stored within the protocol information 225. For example, the most common communication protocols may be ranked higher within the protocol information 225 to attempt to establish communication with the controller 160 in an efficient manner. In still other examples, digital communication based protocols may be selected first due to the reduced time required to determine whether a communication can be established. Furthermore, digital protocols with faster timeout times (e.g., the time for a device to respond to a communication request) may be selected first to optimize the time to establish communication.

In other examples, the instruction is generated based on the electronic processor 210 detecting or sensing one or more input parameters from the I/O interface 230. For example, the electronic processor 210 may generate the first instruction based on detecting a voltage value above a predetermined threshold on an input of the I/O interface 230 associated with hardware line of the electrical connector (e.g., electrical connectors 320a, 320b, 320c) in which the user interface 110 is coupled. Example predetermined threshold values may include 12 VDC, 5 VDC, 3.3 VDC and/or Ground (0 VDC). However, other predetermined voltage levels, including those higher than 12 VDC, are also contemplated.

The generated first instruction is represented as the n^{th} instruction, where the variable n indicates which instruction of the plurality of instructions is currently generated by the electronic processor 210. For example, user interface 110 is first connected to the height adjustable table 100, the n^{th} instruction is a first instruction generated by the electronic processor 210 and is based on the protocol information 225. The first instruction generated is an instruction in accordance with one of the plurality of communication protocols included in the protocol information 225. For example, the first instruction generated may include a LIN protocol header and is configured to excite a first hardware line of the electrical connector (e.g., electrical connectors 320a, 320b, 320c) to which the user interface 110 is coupled.

At process block 460, the n^{th} (e.g., first) instruction is transmitted to the controller 160 from the user interface 110 via the I/O interface 130. In this example, the user interface 110 is acting as a master and the controller 160 acts as a slave. In some embodiments, the first instruction may be an initialization instruction or a reply request. In other embodiments, the first instruction may include a command to perform a movement of the actuators 140a, 140b, or to request a diagnostic response, an error code, an acknowledgement signal, and/or a status request (for example, present height of the height adjustable table 100). The first instruction may further be a test message based on the protocol, in some examples. In one embodiment, the first instruction is configured to provoke a specific response instruction from the controller 160.

At step 470, the user interface 110 determines whether an expected response is received from the controller 160. In some embodiments, the electronic processor 210 analyzes one or more response characteristics of the response received from the controller 160. The response characteristics provide an indication of whether the response to the first instruction is an expected response. In some embodiments, the response characteristic includes an acknowledgement communication from the controller 160. In other embodiments, the response characteristic includes a predetermined voltage or current value, a diagnostic response, an error code, or a status response. The electronic processor 210 may compare the one or more response characteristics to expected responses stored in the protocol information 225 to determine whether the received response is an expected response.

In one example, where the controller 160 is utilizing a LIN protocol, the controller 160 may provide a response to the first instruction acknowledging a transmission has been received. Thus, in this example, the acknowledgement is the determined response characteristic. Accordingly, where the first instruction was associated with a LIN network, the received acknowledgement would indicate that an expected response was received.

In response to the electronic processor 210 determining that an expected response was received at process block 470, the process 400 continues to process block 480 where the electronic processor 210 sets the operational communication protocol to be used for communication with the controller 160. The electronic processor 210 may store the operational communication protocol in the memory 220 for use in future operations. Following the above example, where the electronic processor 210 determined that the transmission of the first instruction yielded an expected result for a controller 160 utilizing a LIN protocol, the electronic processor sets the communication protocol as a LIN protocol. Thus, further operation of the height adjustable table is performed with the user interface 110 by utilizing instructions configured for the LIN protocol. While not described in detail, other factors, such as connector type may also be set based on receiving the expected response.

The process 400 then proceeds to process block 430 where the user interface 110 operates in a normal operation mode and communicates commands received from the input mechanism 150 to the controller 160 at process block 430. Thus, a user may control the height of the height adjustable table 100 via the user interface 110.

Where an expected response is not received at process block 450, the process 400 continues to process block 490. At process block 490, the variable n is incremented by 1. After the variable n is incremented, the process 400 proceeds to process block 450. Thus, following the above example, after generating a first instruction wherein the value of n is one, the process 400 returns to step 430 with two as the value of n and generates a second instruction. The process 400 then proceeds as described above. The second instruction (or any instruction subsequent to the first instruction) are instructions associated with various communication protocols, such as those stored in the protocol information 225.

Returning to step 430, wherein the value of n is two, the instruction generated is a second instruction. Similar to the first instruction, the second instruction generated is based on the protocol information 225. Additionally, the second instruction generated is an instruction configured in accordance with one or both of a different one of the plurality of communication protocols and/or a different hardware line (e.g., electrical connector type) than that of the first instruction. For example, the second instruction generated may be configured for a direct contact protocol and excite a second hardware line of the electrical connector. The process 400 then proceeds as described above, starting at process block 460.

Accordingly, the process 400 is configured to repeat until the user interface 110 determines that a response characteristic of the controller 160 is in accordance with an expected response characteristic. In one example, the first instruction generated by the user interface 110 is configured for LIN protocol and a first hardware line of the electrical connector. The user interface 110 determines that an expected response was not received from the controller 160 (e.g., no response), thus the variable n is incremented, and a second instruction is generated and configured for LIN protocol and a second hardware line of the electrical connector. After the second instruction is transmit to the controller 160, the user interface 110 again determines that an expected response was not received from the controller 160. Again, the variable n is incremented, and a third instruction is generated based on the protocol information 225, wherein the third instruction is configured for three wire direct contact and the second hardware line of the electrical connector. After transmitting the third instruction to the controller 160, the user interface 110 determines an expected response has been received from the controller 160 (e.g., detecting a voltage value exceeding a predetermined threshold). In response to determining an expected response was received, the user interface 110 the determines that an instruction generated for the controller 160 that is configured for three wire direct contact and the second hardware line is in accordance with the configuration of the controller 160. Thus, the user interface 110 determines that subsequent instructions for control of the height adjustable table should be configured for three wire direct contact and the second hardware line. Although specific communication protocols and hardware line configurations are discussed herein as examples, it is to be understood that the process 400 may be performed using any variety of communication protocols and hardware line configurations.

Thus, the invention provides, among other things, for height adjustable tables and, more particularly for a user interface configured to control different height adjustable tables. Various features and advantages of the invention are set forth in the following claims.

What is claimed is:

1. A user interface for a height adjustable table, the user interface comprising:
a memory configured to store protocol information for a plurality of communication protocols; and
an electronic processor configured to:
receive the protocol information from the memory,
generate a first instruction for a controller of the height adjustable table based on a first communication protocol of the plurality of communication protocols stored in the protocol information,
monitor for a first response from the controller,
determine whether the first response is an expected response based on the first instruction;
generate a second instruction for the controller based on a second communication protocol of the plurality of communication protocols in response to the first response being determined to not being the expected response,
monitor for a second response from the controller,
determine whether the second response is the expected response based on the second instruction, and
continue issuing subsequent instructions based on the second response not being determined to be the expected response.

2. The user interface of claim 1, wherein the electronic processor is further configured to control a motor to vary the height of the height adjustable table in response to receiving an expected response.

3. The user interface of claim 1, wherein the expected response includes at least one of a group consisting of a predefined voltage value, a predefined current value, and an acknowledgment message.

4. The user interface of claim 1, wherein the first instruction is an instruction associated with a Local Interconnect Network (LIN) protocol.

5. The user interface of claim 1, wherein the generated instructions are associated with an electrical connector coupling the user interface to the controller.

6. The user interface of claim 5, wherein the electrical connector is one of a DIN connector, an RJ-45 connector, and a four-pin square connector.

7. The user interface of claim 6, wherein the user interface is coupled to the controller via a universal connector.

8. A method for controlling a height adjustable workstation, comprising:
receiving, at an electronic processor, protocol information from a memory in communication with the electronic processor;
generating a first instruction for a controller of the height adjustable workstation based on a first communication protocol of a plurality of communication protocols stored in the protocol information;
monitoring, by the electronic processor, for a first response from the controller in response to the generated first instruction;
determining, by the electronic processor, whether the first response is an expected response based on the first instruction; and
controlling a motor of the height adjustable workstation based on the first response being determined to be the expected response.

9. The method of claim 8, further comprising:
generating, at the electronic processor, a second instruction for the controller based on a second communication protocol of the plurality of communication protocols stored in the protocol information in response to the first response being determined to not be the expected response;
monitoring, at the electronic processor, for a second response from the controller;
determining, by the electronic processor, whether the second response is the expected response based on the second instruction; and
controlling, via the electronic processor, the motor of the height adjustable workstation based on the second response being determined to be the expected response.

10. The method of claim 9, further comprising issuing, by the electronic processor, subsequent instructions in response to the second response being determined to not be an expected response until an expected response is received.

11. The method of claim 8, wherein the expected response includes at least one of a group consisting of a predefined voltage value, a predefined current value, and an acknowledgment message.

12. The method of claim 8, wherein the first instruction is a Local Interconnect Network (LIN) based instruction.

13. The method of claim 8, wherein the generated instructions are associated with an electrical connector coupling the user interface to the controller.

14. The method of claim 13, wherein the electrical connector is one of a DIN connector, an RJ-45 connector, and a four-pin square connector.

15. The method of claim 14, wherein the user interface is coupled to the controller via a universal connector.

16. A height adjustable table, the height adjustable table comprising:
a tabletop;
a leg coupled to the tabletop;
an actuator positioned within the leg and configured to raise and lower the tabletop; and
a user interface configured to receive a user input for controlling the actuator, wherein the user interface includes:
a memory configured to store protocol information for a plurality of communication protocols, and
an electronic processor configured to
receive the protocol information from the memory,
generate a first instruction for a controller associated with the actuator based on a first communication protocol of the plurality of communication protocols stored in the protocol information,
monitor for a first response from the controller,
determine whether the first response is an expected response based on the first instruction,
generate a second instruction for a controller based on a second communication protocol of the plurality of communication protocols in response to the first response not being the expected response,
monitor for a second response from the controller,
determine whether the second response is the expected response based on the second instruction, and
continue issuing subsequent instructions based on the second response not being the expected response.

17. The height adjustable table of claim 16, wherein the electronic processor is further configured to control the actuator to vary the height of the height adjustable table in response to receiving the expected response.

18. The height adjustable table of claim 16, wherein the expected response includes one of a group consisting of a predefined voltage value, a predefined current value, and an acknowledgement message.

19. The height adjustable table of claim 16, wherein the first instruction is an instruction associated with a Local Interconnect Network (LIN) protocol.

20. The height adjustable table of claim 16, wherein the generated instructions are associated with an electrical connector coupling the user interface to the controller, wherein the electrical connector is one of a DIN connector, an RJ-45 connector, and a four-pin square connector.
